(19) United States
(12) Patent Application Publication
(10) Pub. No.: US 2010/0268402 A1
(43) Pub. Date: Oct. 21, 2010

(54) Onboard Starter-Interrupt Device Incorporating Wireless Personal Area Network

(75) Inventors: Stanley G. Schwarz, Littleton, CO (US); Chris Aron, Denver, CO (US); Mary Sue Karlin, Denver, CO (US); Christopher M. Macheca, Centennial, CO (US); Franco Chirico, Highlands Ranch, CO (US); Corey Pelland, Gurnee, IL (US); Debra A. Jones, Schaumburg, IL (US); James C. Graves, JR., St. Charles, IL (US)

Correspondence Address: RAUBVOGEL LAW OFFICE, 820 LAKEVIEW WAY, REDWOOD CITY, CA, 94062, US

(73) Assignee: GORDON * HOWARD ASSOCIATES, INC., Littleton, CO (US)

(21) Appl. No.: 12/826,513

(22) Filed: Jun. 29, 2010

Related U.S. Application Data
(62) Division of application No. 11/684,186, filed on Mar. 9, 2007.

(51) Int. Cl. G06F 19/00; G01C 21/00; H04W 4/00

(52) U.S. Cl. 701/2; 455/466

(57) ABSTRACT

An onboard starter-interrupt device uses a Personal Area Network (PAN) to facilitate communication between a wireless device (such as a cellular telephone or personal digital assistant (PDA)) and the onboard device (also referred to interchangeably as a vehicle control device or a payment enforcement device) installed on a vehicle. The PAN can be implemented using, for example, the well-known Bluetooth protocol. The use of a PAN avoids the need for a visible keypad or other input device installed in the vehicle. The interface with the PAN also facilitates direct communication (including voice communication) using an existing cell phone. The interface with the PAN further allows a user or administrator to configure the operation of the onboard device using input/output components of the wireless device.

### CROSS-REFERENCE TO RELATED APPLICATIONS

The present patent application claims priority as a divisional of U.S. Utility patent application Ser. No. 11/684,186 for “Onboard Starter-Interrupt Device Incorporating Wireless Personal Area Network”, attorney docket number GH006, filed Mar. 9, 2007, the disclosure of which is incorporated herein by reference.

This invention is related to U.S. patent application Ser. No. 11/349,523 for “ENFORCING PAYMENT SCHEDULES”, attorney docket number GH002, filed Feb. 7, 2006, the disclosure of which is incorporated herein by reference.

This invention is related to U.S. patent application Ser. No. 11/539,292 for “STARTER-INTERRUPT DEVICE INCORPORATING GLOBAL POSITIONING SYSTEM FUNCTIONALITY”, attorney docket number GH004, filed Oct. 6, 2006, the disclosure of which is incorporated herein by reference.

### FIELD OF THE INVENTION

The present invention relates to the use of a wireless Personal Area Network (PAN), such as a Bluetooth network, in the context of a payment enforcement system that disables, alerts, and locates a vehicle in response to a missed payment or other event.

### DESCRIPTION OF THE RELATED ART

Lenders have various mechanisms for enforcing payment of debt obligations, particularly those obligations that arise from the sale of goods or property on credit. For example, mortgagees can foreclose on real property if a mortgagor defaults. Vehicle finance companies can repossess a vehicle in the event the owner fails to make timely payment.

In some cases, foreclosure payment schedule enforcement mechanisms are expensive and/or cumbersome to implement. Accordingly, lenders often refuse to extend credit when the likelihood of default exceeds some amount, because of the expense or impracticality of repossessing or otherwise enforcing payment obligations. In particular, potential buyers with poor credit history may be denied credit when attempting to purchase a vehicle or other item because of the relatively high likelihood of default. In addition, payments on less expensive items such as appliances, computers, and the like are often difficult to enforce because repossession is far too expensive in relation to the value of the item itself, and because the item loses much of its value once it is used.

Payment enforcement systems exist whereby a vehicle (or other purchased property) is equipped with a device capable of disabling the vehicle in the event of non-payment. Whenever the purchaser/owner makes a timely payment, he or she is given a password to enter on a keypad installed in the vehicle. Entry of the password enables the vehicle for some limited period of time (usually until the next payment due date, plus some grace period). Failure to enter the password causes the vehicle to be disabled, for example by interrupting the starter circuitry. Usually, the owner is given some warning of impending disablement, and may also be provided with a limited number of emergency starts whereby the vehicle can be used a few times even if a code has not been entered. In some variations, the password is transmitted wirelessly to the vehicle so that the owner need not enter it manually.

Such systems, available for example from PassTime USA of Littleton, Colo., are effective in reducing the incidence of delinquency and default. However, widespread implementation and use of such systems is hindered by significant barriers and costs. For example, many such systems require installation of a dedicated onboard device (also referred to interchangeably as a vehicle control device or payment enforcement device) with which the vehicle owner interacts in order to enter passwords, see alerts and notifications, and the like. Such devices can be costly to install and maintain; furthermore, a vehicle owner may resent having such a device because of the stigma associated with having such a visible and prominent indication of the owner's poor credit. The device may also be confusing to operate, difficult to update, and can take up valuable space inside the vehicle.

In addition, it is often useful for vehicle owners to have available to them a direct communication channel to the lender. Without such a communication channel, errors may occur which cause a vehicle to be mistakenly disabled because a lender did not receive (or thought it did not receive) timely payment. Owners may have explanations for tardiness in payment, or may wish to obtain extensions because of valid extenuating circumstances. A direct communication channel to lenders facilitates such advantages.

In addition, lenders often want to know where the vehicle is, particularly in cases of default. Such information would be useful in reducing the cost of repossession. Furthermore, providing such information to lenders can reduce the likelihood of default, particularly if the owner of the vehicle is informed of the fact that location information is being made available to lenders.

What is needed, therefore, is a payment enforcement system that avoids the need for a visible apparatus to be installed in the vehicle. What is further needed is a device that allows user entry of passwords and further facilitates direct communication with lenders, without requiring a visible apparatus.

### SUMMARY OF THE INVENTION

The present invention uses a Personal Area Network (PAN) to facilitate communication between a wireless device (such as a cellular telephone or personal digital assistant (PDA)) and a payment enforcement device installed on a vehicle. The PAN can be implemented using, for example, the well-known Bluetooth protocol.

The onboard payment enforcement device includes starter interrupt circuitry capable of disabling the vehicle by, for example, cutting power to the vehicle's starting system. The onboard payment enforcement device communicates with an operations center to receive instructions from the operations center; these instructions can cause the onboard device to disable or enable the vehicle. The instructions can also cause the onboard device to transmit alerts and other notifications via the PAN for display on the owner's wireless device.

In one embodiment, the owner can communicate directly with personnel at the operations center via the wireless device. Such communication can include SMS, voice, email, and the like. The PAN provides an infrastructure by which the owner's wireless device transmits messages and communications between the wireless device and the onboard device; a separate communication channel exists between the onboard device and the operations center. Thus, a voice communication can be easily established from the owner's wireless device to the operations center, allowing the owner to talk directly to a live human being at the operations center and thereby clear up any errors, request extensions, and the like. In addition, the owner can enter passwords on, for example, a keypad on the wireless device; such passwords are transmitted via the PAN to the onboard device and then relayed to the operations center via a wireless carrier.

In another embodiment, the owner's wireless device is itself used as the communication channel with the operations center. In this variation, the onboard device does not establish its own wireless channel to the operations center, but instead transmits/receives control messages to/from the wireless device (via the PAN), and causes the wireless device to interact wirelessly with the operations center. The communication channel can include data, voice, or both. In this variation the vehicle cannot receive commands from the operations center if the owner does not bring his/her cell phone to the vehicle at least periodically; therefore, fail-safe schemes can be put in place such that unless periodic contact is made with the operations center, the onboard device causes the vehicle to be disabled.

According to the techniques of the present invention, an improved onboard starter-interrupt device incorporates a wireless Personal Area Network (PAN) using a protocol such as Bluetooth in implementing a payment enforcement scheme. Owner interaction with the onboard starter-interrupt device takes place via a cell phone or other PAN-enabled device; where appropriate, the onboard device facilitates communication between the owner and an operations center via the PAN and via the onboard device's own wireless modem or other communication mechanism.

In one aspect, a payment schedule can be configured. If the vehicle owner fails to make payment by a certain date, the operations center can send a message to the onboard device to output alerts, disable the vehicle, provide location information, or any combination thereof in any desired sequence. Disablement alerts and warnings can be communicated to the owner via the PAN, so that alerts appear on the owner's own wireless device. An owner can also directly communicate with the operations center, for example via voice, text, email, or the like, via the PAN.

By combining vehicle disablement technology with a personal area network such as a Bluetooth-enabled network, the present invention provides an improved system and method for enforcing payment schedules and reducing the likelihood and cost of default. Such a system and method provides distinct advantages over prior art schemes, including:

avoiding the need for a visible keypad or other user input device installed in the vehicle;

ability to provide a direct communication channel, including voice communication;

ability to interface with existing communication devices, such as a BlueTooth-enabled cell phone.

### BRIEF DESCRIPTION OF THE DRAWINGS

FIG. 1 depicts an overall architecture for an embodiment of the invention.

FIG. 2A is a flow diagram depicting an example of a method of alerting a vehicle owner of a nonpayment event according to an embodiment of the present invention.

FIG. 2B is a flow diagram depicting an example of a method of alerting a vehicle owner of a payment event according to an embodiment of the present invention.

FIG. 2C is a flow diagram depicting an example of a method of sending a disablement message to an onboard device via a wireless device according to an embodiment of the present invention.

FIG. 2D is a flow diagram depicting an example of a method of sending an enablement message to an onboard device via a wireless device according to an embodiment of the present invention.

FIG. 2E is a flow diagram depicting an example of a method of receiving payment via a wireless device in response to a payment due event according to an embodiment of the present invention.

FIG. 2F is a flow diagram depicting an example of a method of receiving payment via a wireless device according to an embodiment of the present invention.

FIGS. 3A and 3B are flow diagrams depicting examples of methods of enabling direct communication between a vehicle owner and an operations center according to an embodiment of the present invention.

FIGS. 4A and 4B are flow diagrams depicting examples of methods of enabling password entry on a wireless device for validation at an operations center according to an embodiment of the present invention.

FIG. 4C is a flow diagram depicting an example of a method of enabling password entry on a wireless device for validation at the wireless device according to an embodiment of the present invention.

FIG. 4D is a flow diagram depicting an example of a method of enabling password entry on a wireless device for validation at an onboard device according to an embodiment of the present invention.

FIG. 5 is a flow diagram depicting an example of a method of enabling adjustment of preferences and options for an onboard device via a user interface presented at a wireless device according to an embodiment of the present invention.

FIG. 6 is a block diagram depicting a hardware architecture according to one embodiment of the present invention.

FIGS. 7A through 7C are screen shots showing examples of a cell phone based user interface according to one embodiment of the present invention.

### DETAILED DESCRIPTION OF THE EMBODIMENTS

Enforcement of payment schedules in a centralized, flexible manner is described in related co-pending U.S. patent application Ser. No. 11/349,523 for “ENFORCING PAYMENT SCHEDULES”, filed Feb. 7, 2006, the disclosure of which is incorporated herein by reference. As described therein, various types of events can be configured via software running at an operations center. Upon occurrence of a specified event, a message is sent to an onboard device located remotely with respect to the operations center, such as one installed in a vehicle or other product. The onboard device (also referred to interchangeably as a vehicle control device or a payment enforcement device) is configured so that it can disable the vehicle (for example by disabling the starter circuitry) upon receipt of the message from the operations center. In implementations involving products other than vehicles, other mechanisms for disabling the product (such as cutting off power to the product) can be used. The remotely located device can be instructed to allow a certain number of emergency uses, or to accept an override password that re-enables use of the vehicle.

In one embodiment, the onboard device or vehicle control device includes functionality for interfacing with a personal area network (PAN), for example using the well-known Bluetooth protocol. Although the description provided herein sets forth the invention in terms of a Bluetooth-enabled system, one skilled in the art will recognize that other protocols and operational schemes can be used in connection with the present invention, without departing from the essential characteristics of the present invention. For example, the present invention can be implemented using the ZigBee protocol.

In one embodiment, the present invention includes or interfaces with location tracking functionality as described in related to U.S. patent application Ser. No. 11/539,292 for “STARTER-INTERRUPT DEVICE INCORPORATING GLOBAL POSITIONING SYSTEM FUNCTIONALITY”, attorney docket number GH004, filed Oct. 6, 2006, the disclosure of which is incorporated herein by reference. One skilled in the art will recognize that the present invention can be implemented with or without such location tracking functionality.

For illustrative purposes, the description provided herein sets forth the invention in the context of vehicles. However, one skilled in the art will recognize that the invention can be used in connection with any product.

For purposes of the following description, “vehicle owner”, “owner”, and “user” are synonymous and can refer to any individual who is interacting with wireless device 152 and/or onboard device 111.

### Overall Architecture

According to one embodiment, the present invention is implemented as a software application running at an operations center. The software application detects relevant events such as nonpayment and communication requests from owners, and generates messages in response to the events. These messages are received by remotely located devices installed in vehicles or other products. Upon receiving a message, the remotely located device takes one or more appropriate action(s), including for example: opening a communication channel with the owner of the vehicle, disabling the vehicle, transmitting its current location, outputting alerts, or the like. As described in more detail below, the present invention operates in connection with a PAN so that a Bluetooth-enabled cellular telephone (or other similar wireless device) can be used for entry of passwords, display of alerts, voice communication with the operations center, and text or email-based communication with the operations center. The present invention thus avoids the need for a keypad unit to be installed in the vehicle, and further provides additional functionality that allows owners to directly communicate with lenders and thereby avoid unnecessary or unintentional vehicle disablement. Further advantages will become apparent in the course of the following description.

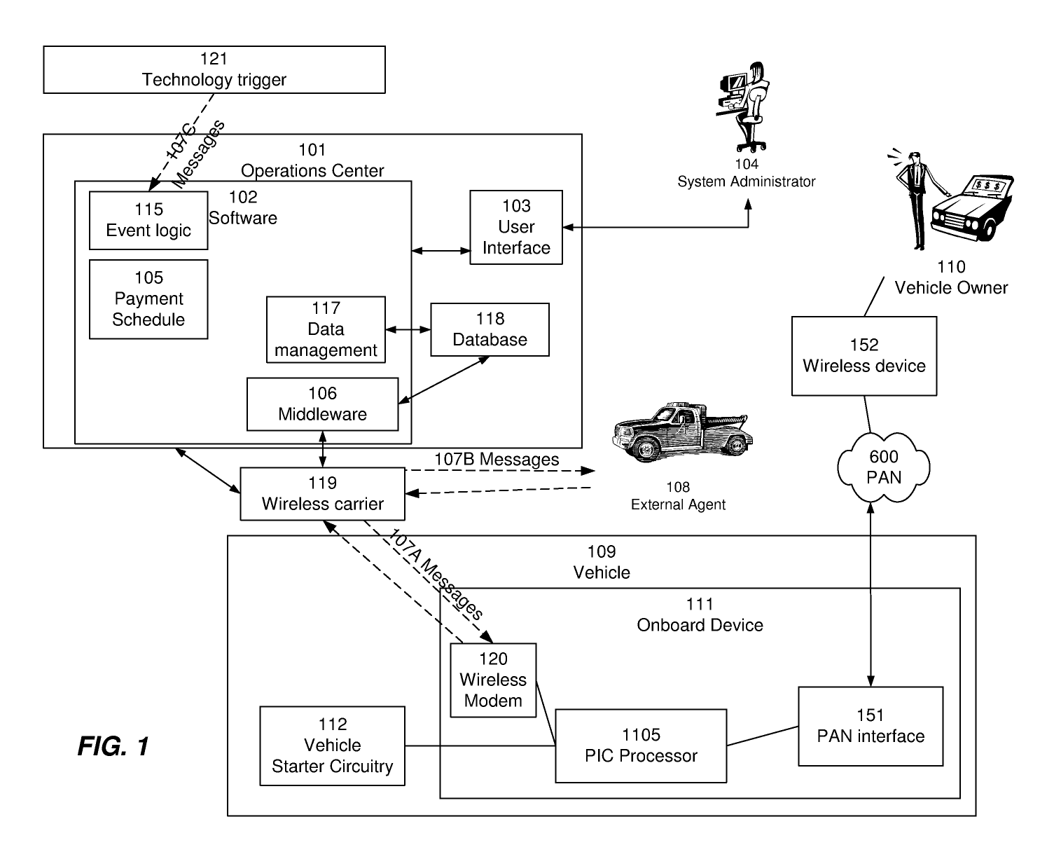

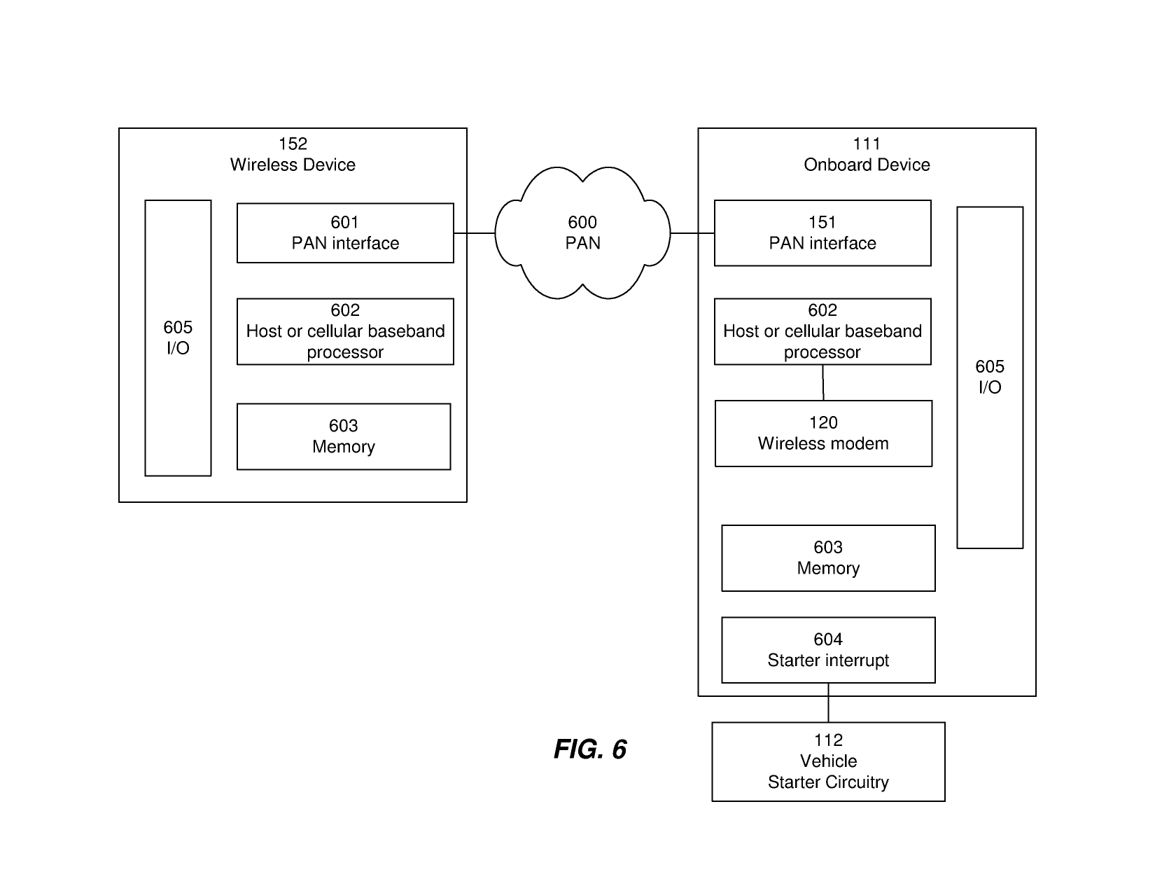

Referring now to FIG. 1, there is shown a block diagram depicting an overall architecture for an embodiment of the invention. Referring now also to FIG. 6, there is shown a block diagram depicting a hardware architecture for wireless device 152 and onboard device 111.

Software 102 runs at operations center 101. In one embodiment, operations center 101 is situated at some central location and is operated by or on behalf of a lender, seller, or loan service company. Appropriate communications infrastructure, such as Internet, wireless, and/or telecommunications connectivity is provided, so as to allow operations center 101 to communicate with other elements of the overall system.

Onboard device 111 is located in vehicle 109 and includes a processor, such as PIC processor 1105, which implements onboard functionality. Onboard device 111 also includes host or cellular baseband processor 602 for facilitating wireless communication on a cellular network such as provided by wireless carrier 119. PIC processor 1105 interfaces with wireless modem 120 for sending and receiving messages. Software running on PIC processor 1105 controls enablement and disablement of vehicle starter circuitry 112. In one embodiment, PIC processor 1105 is communicatively coupled to vehicle starter circuitry 112 to facilitate such disablement when needed. In other embodiments, a starter interrupt module 604 is provided. In other embodiments, PIC processor 1105 is coupled to other vehicle circuitry such as a Controller Area Network (CAN) bus, on-board diagnostic (OBD) port, or the like, so that it can affect operation of vehicle 109 by disabling, curtailing, or limiting certain features and functions of vehicle 109 as appropriate. For example, under certain conditions, vehicle speed and/or vehicle functionality may be limited in response to a nonpayment event. Device 111 also includes memory 603, such as RAM, to enable it to store preferences, configurations, schedules, and the like. In one embodiment, device 111 also includes an input/output component 605 such as a keypad, display, alert system, and the like, also in other embodiments some input components are not needed because wireless device 152 acts as an input device.

PAN interface 151 facilitates operation with Personal Area Network (PAN) 600, which may be for example a network operating in accordance with the Bluetooth protocol, the ZigBee protocol, or any other well-known protocol for implementing a PAN. In one embodiment, for example, PAN interface 151 is a Bluetooth interface that permits onboard device 111 to communicate with a wireless device 152 that is similarly Bluetooth-enabled. Examples of such a wireless device 152 include a cell phone, personal digital assistant (PDA), handheld computer, and the like. Device 152 can be a conventional cellular telephone that is capable of calling any number, or it can be a specialized cell phone that can only be used to communicate with the seller (or lender).

In one embodiment, wireless device 152 includes input/output components 605 including for example an output device such as a screen, an audio output device such as a speaker, and an input device such as a keypad, touch-sensitive screen, keyboard, buttons, rockers, rolling switches, and/or any combination thereof, as is well known in the art of cellular telephones, PDAs and the like. Wireless device 152 also includes a PAN interface 601 for facilitating communication with PAN 600, host or cellular baseband processor 602 for facilitating wireless communication on a cellular network, and memory 603 such as RAM.

Wireless device 152 may be a hand-held device, or it may be installed in vehicle 109. In one embodiment, wireless device 152 is implemented as part of a navigation system such as a portable or in-car GPS-enabled navigation device with BlueTooth functionality. In another embodiment, wireless device 152 communicates with any or of the vehicle's communications network (vehicle bus), engine control module (ECM), transmission control module (TCM), and the like. By communicating with such components, wireless device 152 is able to interact with various components of vehicle 109.

In one embodiment, onboard device 111 transmits messages, via PAN 600, to wireless device 152 for display to owner 110; for example, an alert may appear on device 152 to indicate to the owner 110 that vehicle 109 will be disabled in three days if payment is not received. PAN interface 151 also provides a mechanism by which voice communication with owner 110 can be facilitated via wireless device 152. For example, if owner 110 wishes to communicate directly with an administrator 104 at operations center 101, owner 110 can activate a command on wireless device 152 that enables such communication to take place via PAN.

As described in more detail below, wireless device 152 can be also used as an input device for entry of passwords and the like. The owner can also enter a pass code on the wireless device's 152 keypad; wireless device 152 then communicates with onboard device 111 to enable use of vehicle 109 and/or to send messages 107A to operations center 101 indicating that a pass code has been entered. Validation of the pass code can take place at wireless device 152, or at onboard device 111, or at operations center 101.

As described in more detail below, wireless device 152 can also receive messages via BlueTooth from device 111. For example, status updates, prompts, warnings, and the like, can be displayed on a display screen of wireless device 152 in response to receiving particular messages from device 111. In one embodiment, device 111 sends such messages to wireless device 152 in response to receiving certain types of messages 107A from operations center 101. In one embodiment, device 111 sends such messages when it detects the presence or proximity of device 152, or when owner 110 attempts to start vehicle 109. Messages sent in this manner can be presented to the owner 110 via SMS, voicemail, or any other communication means.

Owner 110 can also use SMS, voice, or other means to send messages to operations center 101, for example to send payment information or the like. In one embodiment, such messages are sent to device 111 using BlueTooth and then relayed to operations center 101. In one embodiment, data communications are enabled by first issuing AT commands, as are well known in the field of modem communication, in order to set up the connection between wireless device 152 and wireless modem 120 in device 111 over PAN 600. AT commands can also be used to transfer data between devices 111 and 152.

In one embodiment, voice communication is implemented using a direct communication path between wireless device 152 and operations center 101 over a conventional wireless network, without using PAN 600 as an intermediary. By using conventional wireless telephony methodology, the system can operate with off-the-shelf wireless devices such as cell phones and PDAs. If appropriate, onboard device 111 can provide a telephone number to wireless device 152 via PAN, so as to tell owner 110 what number to dial when trying to reach operations center 101, or to enable automatic dialing.

In another embodiment, wireless device 152 can be a custom device that enables voice communication to operations center 101 using onboard device 111 as an intermediary. In this embodiment onboard device 111 operates essentially as a cell phone and wireless device 152 is equivalent to a Bluetooth headset or similar device.

Alternatively, wireless device 152 can send/receive messages directly to/from operations center 101 for example via SMS or other wireless protocols. Wireless device 152 can then relay appropriate messages to onboard device 111 via PAN 600. In such an embodiment, device 152 acts as an intermediary for messages being sent from operations center 101 to onboard device 111.

In one embodiment, device 152 can also include RF functionality, a card-swiper, or the like (not shown). Data collected using such input methods can be sent to device 111 via PAN 600. For example, if the owner 110 swipes a credit card for payment purposes, device 152 can relay the credit card information to device 111 and/or to operations center 101 to enable continued operation of vehicle 109.

Wireless device 152 can also be used for programming and setting preferences on onboard device 111. For example, in one embodiment, a service mode is available for use by an administrator or other representative of operations center 101 or lender. A service password may be required before entering such a service mode. While in the service mode, the administrator can specify warning periods, alert parameters, and other settings using a user interface on device 152. Device 152 communicates with device 111 via PAN 600 to cause such settings to be implemented on onboard device 111. In one embodiment, the vehicle owner 110 can specify user preferences in a similar manner, although without having to enter a service password.

System administrator 104 interacts with software 102 via user interface 103, which allows system administrator 104 to specify options, schedules, alert conditions, and the like, and also allows system administrator 104 to view reports, monitor system operations, and the like. System administrator 104 may be located at or near operations center 101, or may be remotely located, in which case interactions with software 102 may take place over a computer network such as the Internet, virtual private network, or the like, according to techniques that are well known to those of skill in the art.

Technology trigger 121 provides messages 107C specifying events that have occurred. Technology trigger 121 can be any source of information that is relevant to the payment schedule enforcement mechanism of the present invention. For example, technology trigger 121 may be a data stream providing information from a payment system, so that upon receipt of messages 107C from technology trigger 121, software causes payment schedule 105 and/or other information to be updated.

Event logic 115 specifies what actions should be taken in response to such messages 107C. For example, technology trigger 121 can inform software 102 that a payment has been received, or that a payment has been missed, or that some other event has taken place. Event logic 115 tells software 102 what to do in response to such events.

Payment schedule 105 for a particular debtor is stored, for example, in a database or other data store at operations center 101 or at some other location. Software 102 enforces payment schedule 105 by sending appropriate messages according to event logic 115, on-demand needs, or local override. Software 102 is communicatively coupled with accounting systems (not shown) or other sources of data that inform software 102 when a payment is late or when other relevant events take place that require messages 107A, 107B to be sent.

In one embodiment, software 102 also includes data management module 117, which maintains customer information, financial controls, verification data to ensure authenticity of messages 107A from vehicles 109, and the like. Such information can be stored in database 118, which in one embodiment is implemented as a SQL server database. Data management module 117 can also maintain payment schedules 105, and can specify changes to event logic 115, under the control of user interface 103.

In one embodiment, software 102 invokes middleware 106 to send messages 107A, via wireless carrier 119, to modem 120 associated with device 111 at vehicle 109. In one embodiment, middleware 106 can also be used for sending messages 107B to external agent 108, although in other embodiments messages 107B are sent directly by software 102. For example, middleware 106 can communicate with a cellular network via Internet Protocol; messages are then sent via the cellular network using a GSM or other protocol to modem 120 in vehicle 109. External agent 108 can receive information regarding vehicle 109 by other means, for example by receiving email messages from operations center 101, or by logging onto a web site run by operations center 101.

In one embodiment, messages are sent using an Access Point Name (APN) associated with a wireless carrier 119 communicating via a GPRS protocol. Any other network or protocol can be used, including for example GSM, CMDA, or the like. The APN enables sending and/or receiving messages to external agent 108 and/or wireless modem 120 on onboard device 111. Middleware 106 provides an interface by which software 102 can communicate with many different types of devices, systems, computers, vehicles, nodes, and the like, via a variety of protocols, to provide mobile device control and data acquisition functionality. Essentially, middleware 106 acts a protocol translation module between software 102 and whatever entities software 102 communicates with. For example, for certain devices 111, Internet Protocol (IP) may be an appropriate communication medium, whereas cell or pager messages may be the appropriate mechanism for other devices 111. Examples of other communication protocols that can be used include GPRS, SMS Edge, Java, SQL and the like. In one embodiment, the present invention is implemented using mobile device middleware available from Intellimatics of Coppell, Tex. Standard ODBC protocols can be used to communicate with Intellimatics databases (via standard SQL commands, a SQL Server database, and UDP, SMS, and/or TCP/IP messaging protocols).

Event management middleware 106 sends messages 107A to remotely located device 111 installed in vehicle 109. In one embodiment, modem 120 in device 111 receives such messages 107A. Messages 107A instruct device 111 to perform various operations, such as disabling vehicle starter circuitry 112 in order to prevent operation of vehicle 109, outputting alerts or other information to owner 110 via PAN 600 and wireless device 152, or the like.

In addition to sending messages 107A and/or 107B, in one embodiment, middleware 106 can also receive messages. For example, middleware 106 may receive acknowledgement messages from device 111 and/or agent 108 to confirm receipt of messages 107A and/or 107B. In an alternative embodiment, middleware 106 can be omitted, and software 102 communicates directly with device 111 via wireless carrier 119 to exchange such information.

Although the present invention is described in connection with an embodiment using middleware 106, one skilled in the art will recognize that other embodiments are possible. In particular, middleware 106 can be omitted, so that software 102 communicates directly with onboard device 111 and/or external agent 108, as appropriate.

### Methods of Operation

The following description sets forth a number of methods of operation according to various embodiments of the present invention. One skilled in the art will recognize that other methods of operation can also be implemented without departing from the essential characteristics of the present invention.

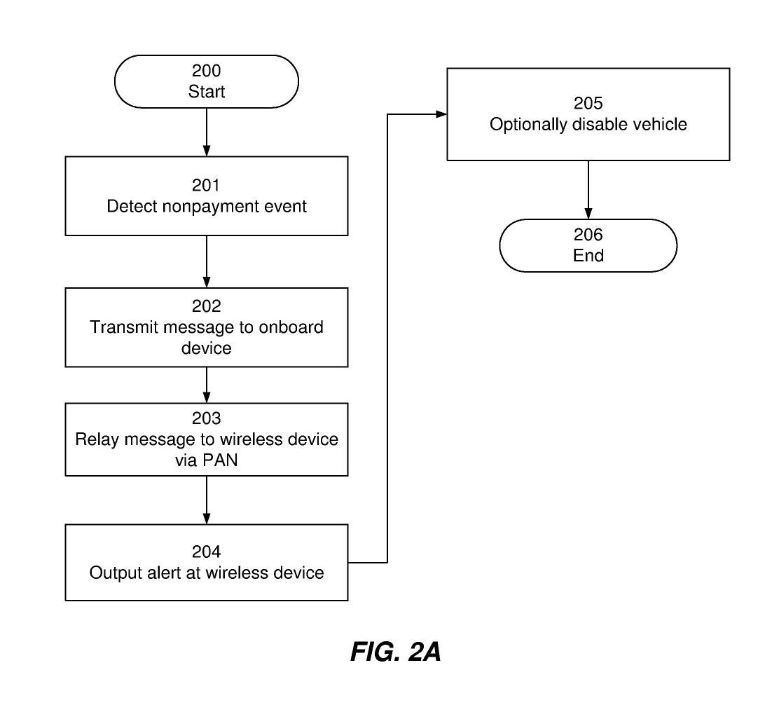

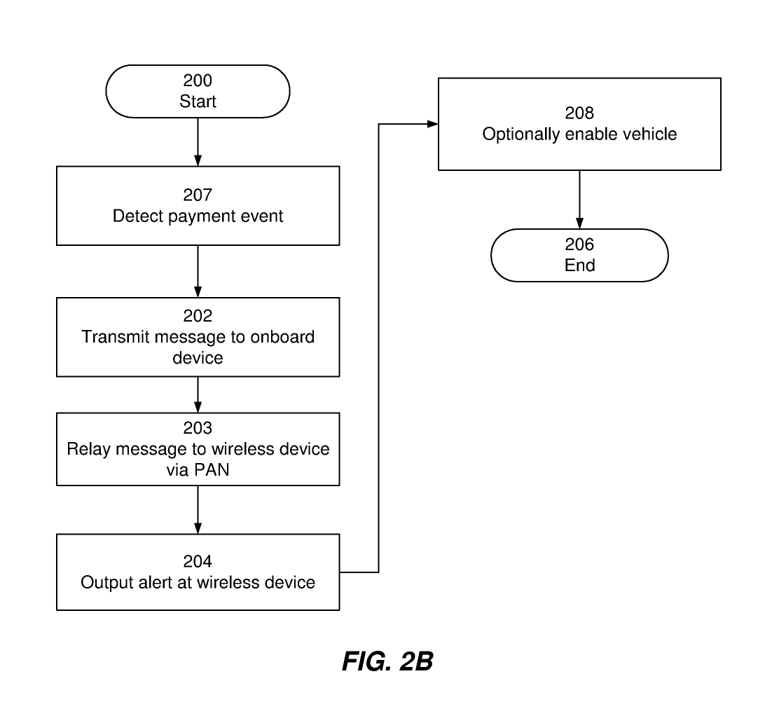

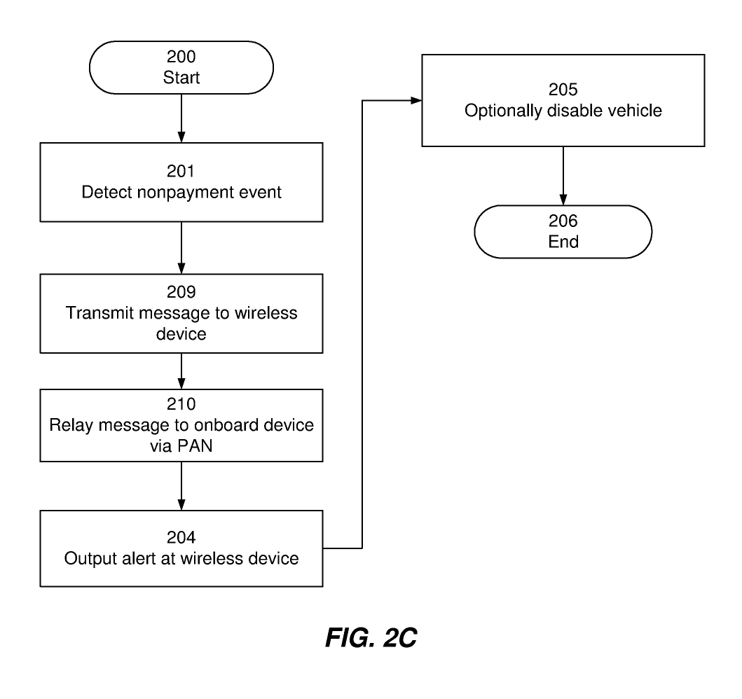

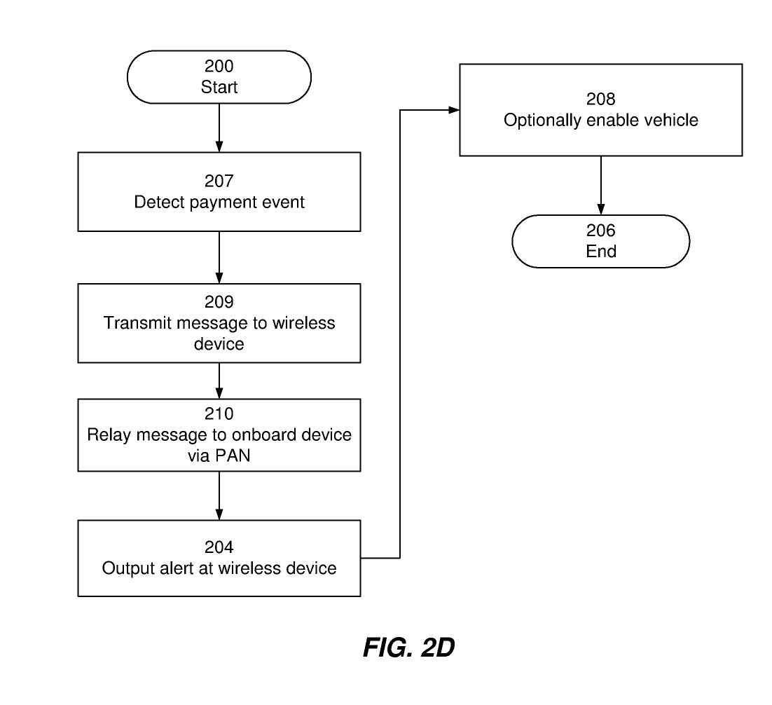

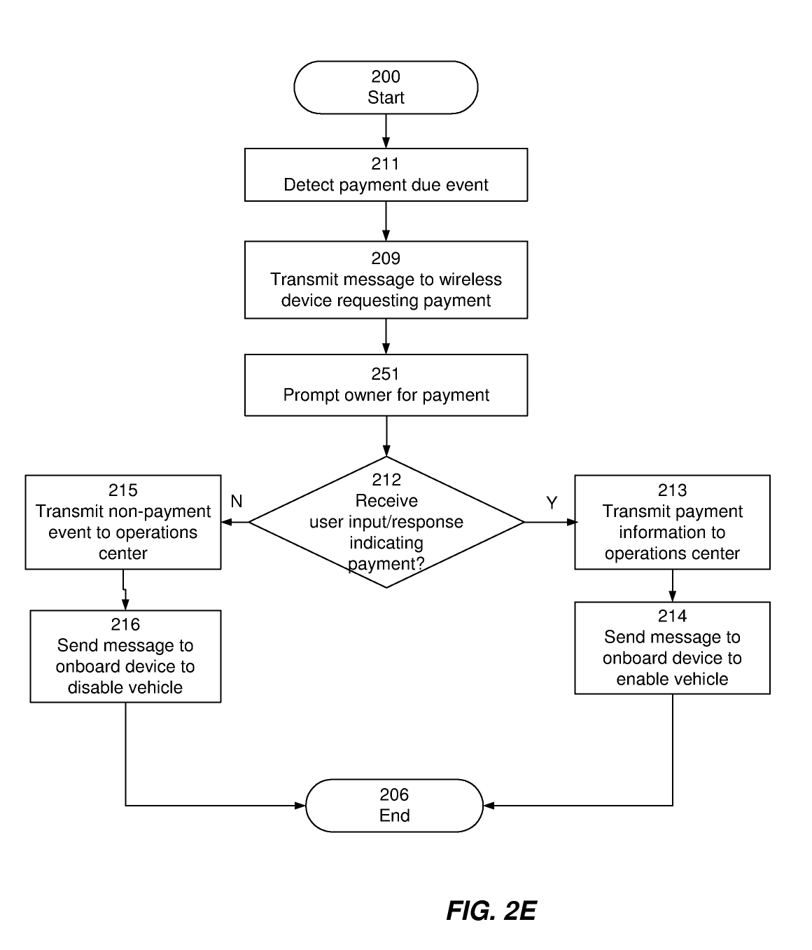

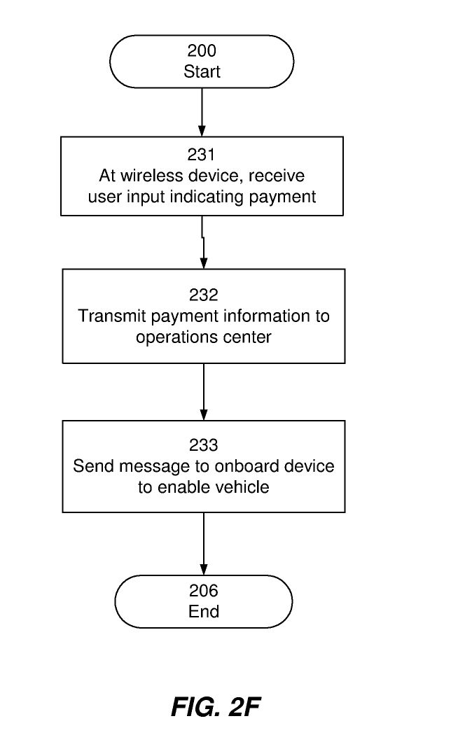

Referring now to FIG. 2A, there is shown a flowchart depicting an example of a method of alerting a vehicle owner of a nonpayment event according to an embodiment of the present invention. A nonpayment event is detected 201. (Alternatively, the method of FIG. 2 can be performed in response to other types of events such as geo-fence violations described in the above-referenced related patent application.) In response to the event, operations center 101 transmits message 107A to onboard device 111. In one embodiment, message 107A is transmitted by middleware 106 across wireless carrier 119 to wireless modem 120 at device 111.

Message 107A can be of any form or type. In one embodiment, message 107A indicates that an alert should be displayed to vehicle owner 110; for example, in response to a nonpayment event it may be desirable to alert vehicle owner 110 that he or she has five days to make payment before vehicle 109 will be disabled.

According to the techniques of the present invention, wireless device 152 is used for displaying or otherwise communicating such alerts to vehicle owner 110. Thus, device 111 relays 203 the message to wireless device 152 via PAN 600, and device 152 outputs 204 the appropriate alert. For example, device 152 may display a text message, or may sound a beep, or may play a voice message specifying the details of the alert. Furthermore, as described below, wireless device 152 may display an option that allows owner 110 to initiate direct contact with an administrator 104 at operations center 101. Should owner 110 activate this option, voice communication (or other communication such as Short Message Service (SMS), push-to-talk, or email) is enabled via PAN 600 and, in turn, via wireless carrier 119 to operations center 101.

If appropriate, device 111 also disables 205 vehicle 109; such action may be appropriate, for example, if owner 110 has previously been warned of the payment delinquency and has been given ample opportunity to cure the problem. In one embodiment, device 111 disables 205 vehicle 109 by interacting with vehicle starter circuitry 112. In other embodiments, other techniques are used such as for example sending messages via the vehicle's 109 CAN bus.

As indicated above, the system of the present invention can be used with products other than vehicles as well, in which case device 111 might be located in or attached to whatever product is subject to being remotely disabled according to the methods provided herein. In such embodiments, device 111 is configured and situated so that it is capable of disabling the subject product when it receives a message instructing it to do so. For example, device 111 can be configured to be able to shut off a power source (such as 110-volt AC) to an appliance or other product.

In one embodiment, device 111 receives communications from middleware 106 via the same physical medium as is used to power the product (such as AC power lines). Such an arrangement prevents owner 110 (or some other individual) from disabling communications with middleware 106 without also cutting off power to the product. Such an embodiment may be effective for payment enforcement on appliances that run on AC power.

Device 111 can include additional components to enhance functionality. In one embodiment, device 111 includes a WiFi repeater to enable communication with vehicle 109 or other products. The repeater is capable of enabling and/or disabling certain actions within the vehicle such as fuel, ignition, or other components. Device 111 can communicate with middleware 106 using any wireless or wired communication channel, including for example Internet, cellular, radio, GSM, pager, or the like. In one embodiment, device 111 periodically polls middleware 106 for messages; alternatively, device 111 is passive and only responds when middleware 106 sends messages. In one embodiment, device 111 has an IP address so that it can be directly addressed via the Internet protocol.

Messages 107A and 107B may be encoded using any known encoding scheme or protocol. In one embodiment, messages 107A and 107B are password-protected and/or encrypted to reduce the possibility of interception and/or tampering.

Referring now to FIG. 2B, there is shown a flowchart depicting an example of a method of alerting a vehicle owner of a payment event according to an embodiment of the present invention. The method of FIG. 2B is similar to that of FIG. 2A, although it is performed in response to a payment event (such as an indication that payment has been received). In response to detection 207 of such an event, message 202 is transmitted to onboard device 111 and relayed 203 to wireless device 152 via PAN 600. Device 152 outputs 204 an alert informing the owner 110 that payment has been received and that continued operation of vehicle 109 is therefore enabled. Optionally, receipt of the message at onboard device 111 causes device 111 to enable 208 operation of vehicle 109.

Referring now to FIG. 2C, there is shown a flowchart depicting an example of a method of sending a disablement message to onboard device 111 via wireless device 152 according to an embodiment of the present invention. Here, upon detection 201 of a nonpayment event, operations center 101 transmits 209 a message directly to wireless device 152 using a wireless carrier or equivalent. Wireless device 152 then relays a message 210 to onboard device 111 via PAN 600, instructing device 111 to disable vehicle 109. In effect, then, wireless device 152 effectively forms part of the communications conduit between operations center 101 and onboard device 111. Wireless device 152 also outputs 204 an alert or other message to owner 110. Device 111 disables 205 vehicle 109.

In one embodiment, when wireless device 152 outputs 204 the alert, vehicle owner 110 is given an opportunity to respond, to provide payment information, or to communicate directly with operations center 101 for example via voice communications. In this way, vehicle owner 110 is given an opportunity to convince operations center 101 to cancel or reverse the disablement of vehicle 109.

Referring now to FIG. 2D, there is shown a flowchart depicting an example of a method of sending an enablement message to onboard device 111 via wireless device 152 according to an embodiment of the present invention. The method of FIG. 2D is similar to that shown in FIG. 2C, except that an enablement message is being sent in response to a payment event. Upon detection 207 of a payment event, operations center 101 transmits 209 a message directly to wireless device 152 using a wireless carrier or equivalent. Wireless device 152 then relays a message 210 to onboard device 111 via PAN 600, instructing device 111 to enable vehicle 109 (if vehicle 109 has previously been disabled). Alternatively, the message to device 111 can specify an extension of an operability period for vehicle 109, for example in an environment where a “fail-safe” system has been implemented that results in automatic disablement unless periodic extensions are received. Wireless device 152 also outputs 204 an alert or other message to owner 110 indicating that the payment event has been processed and acknowledged. Device 111 performs the appropriate action 208 to enable vehicle 109, if required.

Referring now to FIG. 2E, there is shown a flow diagram depicting an example of a method of receiving payment via wireless device 152 in response to a payment due event according to an embodiment of the present invention.

Operations center 101 detects 211 a payment due event, and transmits 209 a message to wireless device 152 requesting payment. Alternatively, the message can be sent to onboard device 111 which relays it to wireless device 152. Alternatively, wireless device 152 can be equipped to periodically request payment on its own without receiving communication from operations center 101.

Wireless device 152 prompts 251 owner 110 for payment. Owner 110 may reply by entering a credit card number, or bank account number, or by other means. Alternatively, owner 110 may swipe a credit card at a swiper device (not shown) connected to wireless device 152 or to onboard device 111. Alternatively, owner 110 may wave an RF-enabled key fob at an RF detector (not shown) connected to wireless device 152 or to onboard device 111. In any case, if user input or response is received 212 indicating payment, wireless device 152 transmits 213 payment information to operations center 101. Alternatively, payment information can be transmitted to onboard device 111 via PAN 600 and relayed to operations center 101. Wireless device 152 sends a message 214 to onboard device 111 to enable vehicle 109 operation. Alternatively, the message to device 111 can specify an extension of an operability period for vehicle 109, for example in an environment where a “fail-safe” system has been implemented that results in automatic disablement unless periodic extensions are received.

If, in 212, no user input or response indicating payment is received, wireless device 152 transmits 215 non-payment information to operations center 101. Alternatively, payment information can be transmitted to onboard device 111 via PAN 600 and relayed to operations center 101. Wireless device 152 sends a message 216 to onboard device 111 to disable vehicle 109 operation.

Referring now to FIG. 2F, there is shown a flow diagram depicting an example of a method of receiving payment via wireless device 152 according to an embodiment of the present invention. Owner 110 provides 231 user input at wireless device 152 to indicate payment, for example by entering a credit card number, or bank account number, or by other means. Alternatively, owner 110 may swipe a credit card at a swiper device (not shown) connected to wireless device 152 or to onboard device 111. Alternatively, owner 110 may wave an RF-enabled key fob at an RF detector (not shown) connected to wireless device 152 or to onboard device 111. Wireless device 152 transmits 232 payment information to operations center 101. Alternatively, payment information can be transmitted to onboard device 111 via PAN 600 and relayed to operations center 101. Wireless device 152 sends a message 233 to onboard device 111 to enable vehicle 109 operation. Alternatively, the message to device 111 can specify an extension of an operability period for vehicle 109, for example in an environment where a “fail-safe” system has been implemented that results in automatic disablement unless periodic extensions are received.

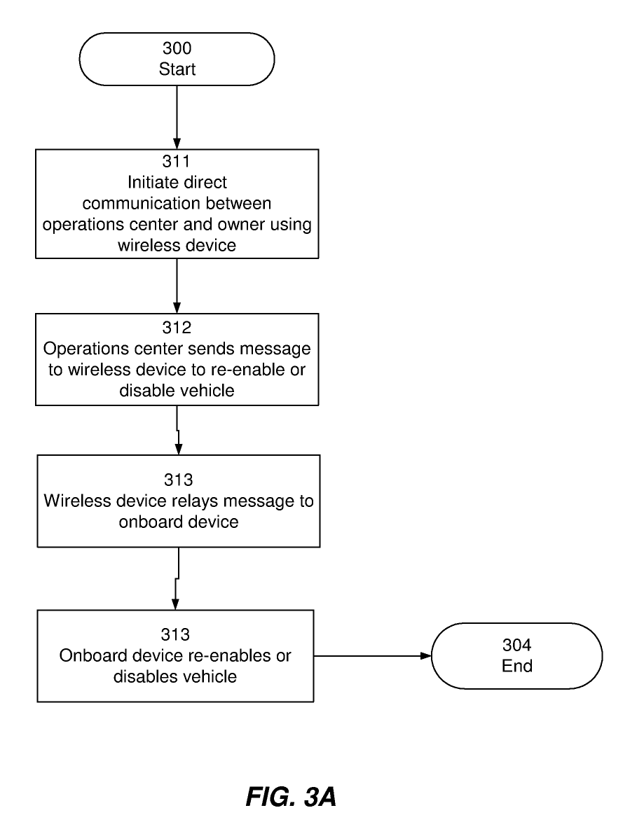

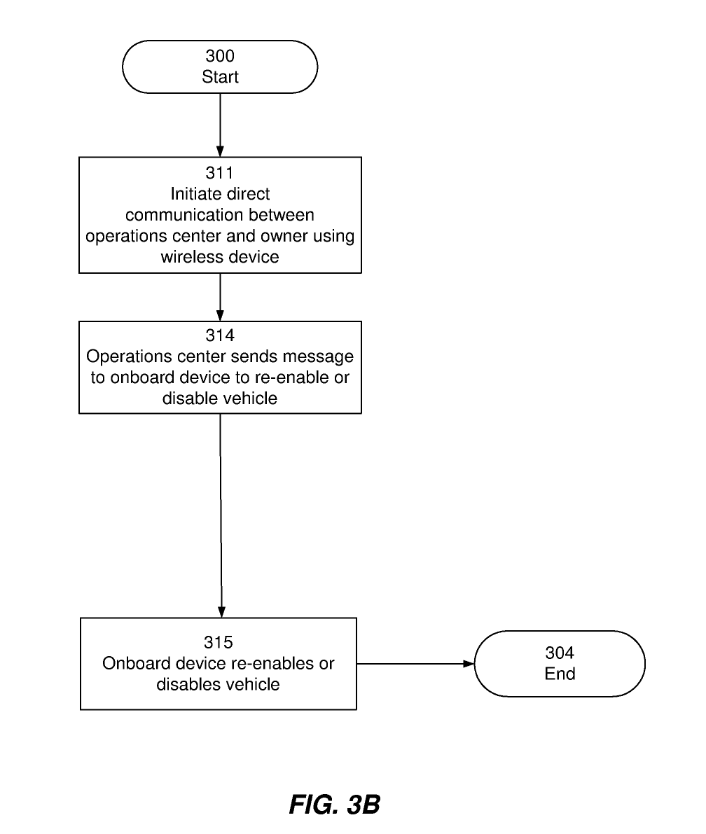

Referring now to FIG. 3A, there is shown a method of enabling direct communication between a vehicle owner and an operations center according to an embodiment of the present invention. Wireless device 152 can be used for initiating direct communication between operations center 101 and owner 110, at the behest of either party. In one embodiment, vehicle owner 110 or other user may request direct communication with operations center 101 to alert operations center 101 as to an impending payment delay, absence, or other information. Alternatively, an administrator 104 at operations center 101 may wish to contact owner 110, in order to check on status of a payment, expired credit card information, or other concerns, or the communication may be initiated automatically in response to some triggering event.

In either case, direct communication is initiated 311, for example using a conventional cellular network. The communication mechanism can include any or all of voice, SMS, email, or the like. As part of the communication, if appropriate, operations center 101 can send 312 a message to wireless device 152 to re-enable or disable vehicle 109; wireless device 152 relays 313 such a message to onboard device 111, which in turn re-enables or disables 313 vehicle 109. For example, if, in the course of communicating with operations center 101, owner 110 initiates a payment process for example by authorizing a bank account debit, it may be appropriate to re-enable vehicle 109 after a previous disablement.

FIG. 3B depicts a method similar to that shown in FIG. 3A. However, in FIG. 3B, operations center 101 sends 314 a re-enablement or disablement message directly to onboard device 314 (for example via wireless carrier 119); onboard device 314 in turn re-enables or disables 315 vehicle 109.

In one embodiment, owner 110 can initiate communication with an emergency services provider or roadside assistance provider via wireless device 152.

In an alternative embodiment, in response to a request to initiate communication 311, device 111 initiates wireless communication with wireless device 152 via PAN 600, and further initiates communication with operations center 101 via wireless modem 120 and wireless carrier 119. Device 111 thus functions as an intermediary in facilitating communication between wireless device 152 and operations center 101.

In one embodiment, the communication between owner 110 and operations center 101 is a live voice communication that is enabled using known Bluetooth protocols. In other embodiments, other communication means are implemented such as text (SMS) messaging, email messages, GSM, MMS, ZigBee, and/or the like.

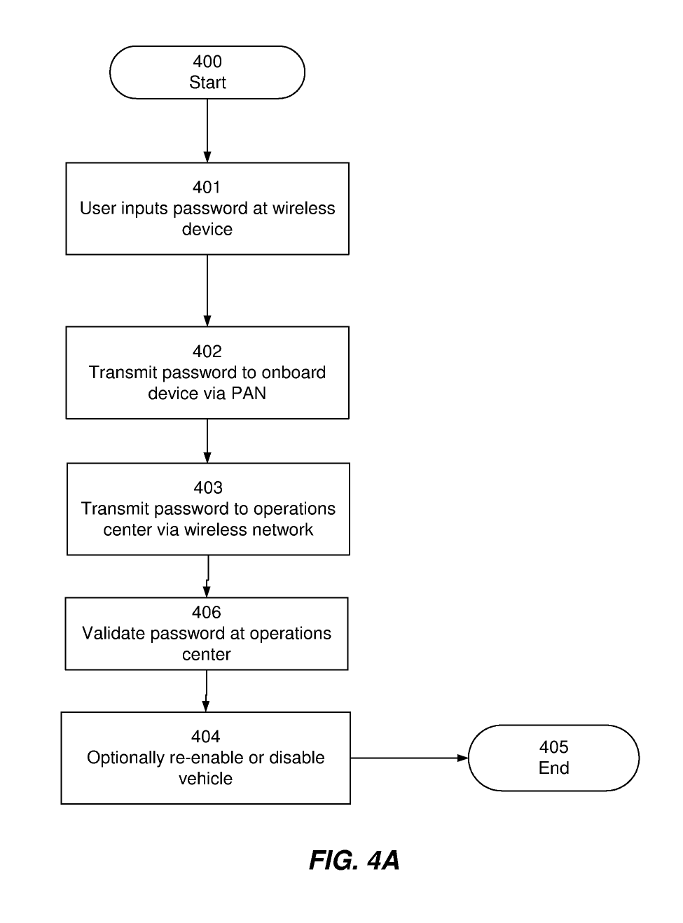

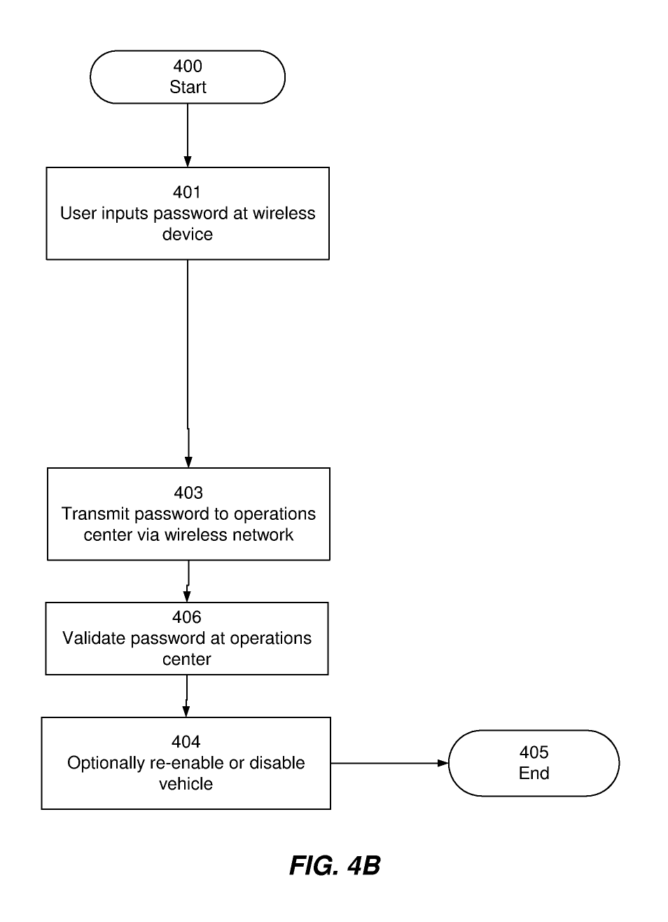

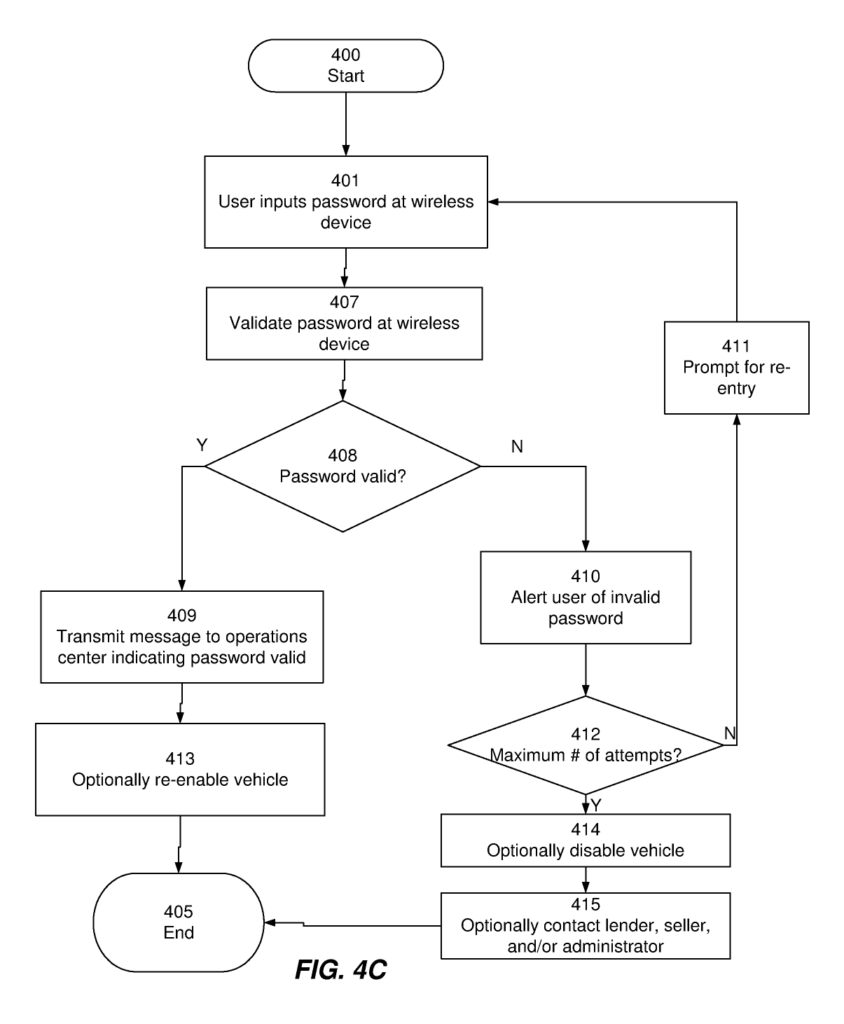

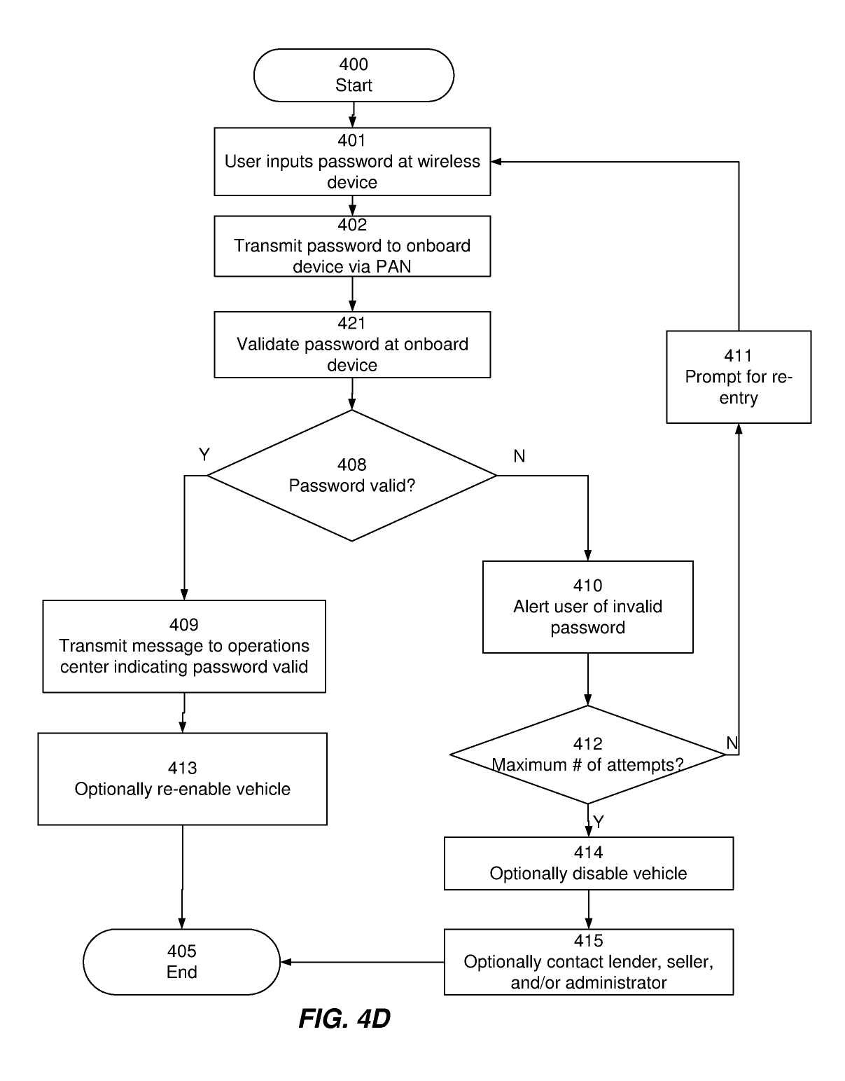

Referring now to FIG. 4A, there is shown a flow diagram depicting an example of a method of enabling password entry on wireless device 152 for validation at operations center 101 according to an embodiment of the present invention. In embodiments where vehicle owner 110 is given a password that enables continued use of vehicle 109, a keypad or other input component of wireless device 152 can be used to receive such password. Accordingly, the method begins with user input 401 of the password at wireless device 152. The password may be encrypted at wireless device 152 for greater security. The password is then transmitted 402 to onboard device 111 via PAN 600. Onboard device 111 forwards 403 the password via wireless carrier 119 to operations center 101. At operations center 101, the password is validated 406. If the password is in fact valid, operations center 101 transmits a message (either directly to onboard device 111 or via wireless device 152) causing vehicle 109 operation to be re-enabled or enabled 404. Alternatively, the message can specify that an operability period for vehicle 109 should be extended for some period of time, for example in an environment where a “fail-safe” mode of operation is in place. If the password is not valid, operations center 101 can optionally transmit a message to wireless device 152 to prompt the owner 110 to re-enter the password; alternatively, or after some number of failed attempts, operations center transmits a message (either directly to onboard device 111 or via wireless device 152) causing vehicle 109 operation to be disabled 404. In an environment where a “fail-safe” mode of operation is in place, no message need be sent, as the operability period for vehicle 109 will expire of its own accord, at which point device 111 automatically disables vehicle 109 until it receives instructions to the contrary.

FIG. 4B depicts a method similar to that of FIG. 4A, except that the password is transmitted directly from wireless device 152 to operations center 101 (for example via a cellular telephone network), without being relayed through onboard device 111. Any known technique can be used for such transmission, voice/DTMF tones, SMS, email, or the like.

Referring now to FIG. 4C, there is shown a flow diagram depicting an example of a method of enabling password entry on wireless device 152 for validation at wireless device 152 according to an embodiment of the present invention. The user, such as owner 110, inputs 401 the password at wireless device 152. Wireless device 152 validates 407 the entered password using validation software or other component(s) that allow it to determine whether the entered password is valid. If wireless device 152 determines 408 that the entered password is valid, wireless device 152 transmits 409 a message to operations center 101 indicating that a valid password has been entered; this transmission 409 can take place directly, or via PAN 600 and onboard device 111. In one embodiment the password itself is not sent, so as to minimize the possibility of interception. Also, wireless device 152 can display a message to owner 110 to indicate that the entered password is valid. Operations center 101 transmits a message (either directly to onboard device 111 or via wireless device 152) causing vehicle 109 operation to be re-enabled or enabled 413. Alternatively, the message can specify that an operability period for vehicle 109 should be extended for some period of time, for example in an environment where a “fail-safe” mode of operation is in place.

If wireless device 152 determines 408 that password is not valid, it displays 410 a message to owner 110 to indicate that the entered password is not valid, and determines 412 whether a maximum number of password entry attempts have been made. If the maximum number has not been reached, wireless device 152 prompts 411 the owner 110 to re-enter the password. If the maximum number of attempts has been made, in one embodiment operations center transmits a message (either directly to onboard device 111 or via wireless device 152) causing vehicle 109 operation to be disabled 414. In an environment where a “fail-safe” mode of operation is in place, no message need be sent, as the operability period for vehicle 109 will expire of its own accord, at which point device 111 automatically disables vehicle 109 until it receives instructions to the contrary. In one embodiment, if the maximum number of attempts has been made, operations center contacts 415 the lender, seller, and/or an administrator to inform them of the problem.

In one embodiment, device 152 is locked out after a maximum number of unsuccessful password entry attempts have been made.

FIG. 4D depicts a method similar to that of FIG. 4C, except that the password is transmitted 402 to onboard device 111 and validated 421 at onboard device 111. In one embodiment, the password is encrypted before being transmitted 402. Onboard device 111 validates 421 password. The method then proceeds as described above in connection with FIG. 4C.

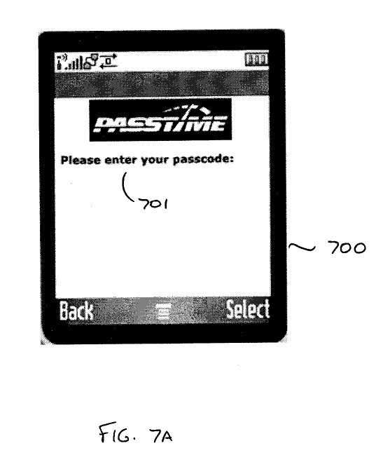

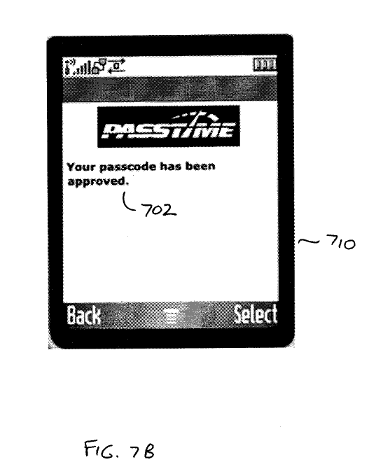

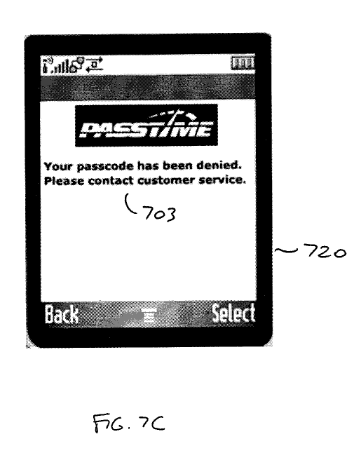

Referring now to FIGS. 7A through 7C, there is shown a series of screenshots depicting a user interface for password entry on a cell phone or similar device according to one embodiment. In FIG. 7A, screen 700 is displayed, including prompt 701 asking the owner to enter a passcode (or password). The owner can enter the password using the keypad of the cell phone or other device. In one embodiment, the password is not displayed on screen 700 for security purposes.

In FIG. 7B, screen 710 includes message 702 indicating that the entered password has been approved.

In FIG. 7C, screen 720 includes message 703 indicating that the entered password has been denied. The owner is advised to contact customer service. In one embodiment, the cell phone can automatically dial customer service; a message such as “Dialing . . . ” can be added to screen 720 to inform the owner that customer service is being called.

One skilled in the art will recognize that the screen shots depicted in FIGS. 7A through 7C are examples only, and that many other layouts and arrangements are possible without departing from the essential characteristics of the present invention.

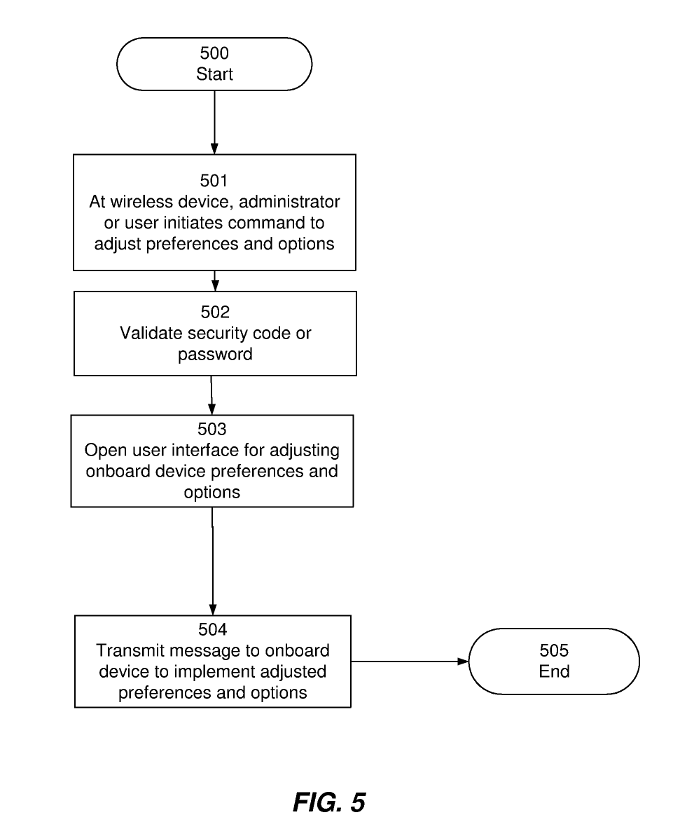

Referring now to FIG. 5, there is shown a flow diagram depicting an example of a method of enabling adjustment of preferences and options for onboard device 111 via a user interface presented at wireless device 152 according to an embodiment of the present invention. Such a method can be initiated by owner 110, for example to set preferences, or it can be initiated by an administrator on behalf of operations center 101, for example to set warning periods and other parameters for operation of onboard device 111.

At wireless device 152, the administrator or other user (such as owner 110) initiates 501 a command to adjust preferences and/or options. If appropriate, a password or security code is validated 502 or a biometric validation mechanism is invoked to ensure that the individual attempting to make the adjustments is authorized to do so. A user interface is then opened 503 that permits the individual to adjust the operation of onboard device 111. Once the individual confirms the changes, a message is transmitted 504 to onboard device 111 to implement the adjustments. In this manner, the keypad and/or other input mechanisms of wireless device 152 can be used as an interface for controlling the operation of onboard device 111.

The above description includes various specific details that are included for illustrative purposes only. One skilled in the art will recognize the invention can be practiced according to many embodiments, including embodiments that lack some or all of these specific details. Accordingly, the presence of these specific details is in no way intended to limit the scope of the claimed invention.

In the specification, certain components of the invention may be described in terms of algorithms and/or steps performed by a software application. In many cases, such descriptions are intended to set forth the invention using representations that are commonly used among those of skill in the arts. Accordingly, any descriptions that refer to algorithms, method steps, functional components, and the like, shall be considered to encompass electrical, magnetic, optical, and/or mechanical signals representing such algorithms, method steps, functional components, such signals being capable of being stored, transmitted, input, output, and/or otherwise manipulated. Reference to these signals as variables, bits, symbols, values, and the like may appear herein and is not intended to limit the scope of the claimed invention in any way.

All such terms, and any similar terms, are to be considered labels only, and are intended to encompass any appropriate physical quantities or other physical manifestations. Any particular naming or labeling of the various modules, protocols, features, and the like is intended to be illustrative; other names and labels can be used.

In addition, various terms such as “processing”, “calculating”, “determining”, “transmitting”, or the like, may be used herein. Such terms are intended to refer to processes performed by a software and/or hardware device such as a computer system. Such terms refer to various types of manipulation and/or transformation of physical and/or electronic components such as registers and memories within the device. These physical and/or electronic components typically represent data elements to be transformed, transmitted, and/or output.

Furthermore, the invention can be implemented as a method, system, computer program product, user interface, or any combination thereof.

The present invention also relates to a system for performing various steps and operations as described herein. This system may be a specially-constructed device such as an electronic device, or it may include one or more general-purpose computers that can follow software instructions to perform the steps described herein. Multiple computers can be networked to perform such functions. Software instructions may be stored in any computer readable storage medium, such as for example, magnetic or optical disks, cards, memory, and the like.

The method steps, user interface layouts, displays, and other components described herein can be implemented on any computer, network, or other apparatus capable of performing the functions described. No limitation as to operation on a particular type of system or apparatus is implied. No particular programming language is required; rather, any type of programming language can be used to implement the present invention.

References to “one embodiment” or “an embodiment” indicate that a particular element or characteristic is included in at least one embodiment of the invention. Although the phrase “in one embodiment” may appear in various places, these do not necessarily refer to the same embodiment.

One skilled in the art will recognize that the invention can be practiced according to many embodiments other than those described herein, without departing from the essential characteristics of the present invention. The particular descriptions set forth above are intended to be illustrative examples only, and are not intended to limit the scope of the invention.

1. In a system for relaying an alert concerning a trigger event to a user, an onboard device located on a vehicle, the onboard device comprising:
a wireless communications interface for receiving, from an operations center remotely located with respect to the vehicle, a message comprising an alert concerning a trigger event;
a personal area network interface for relaying the alert to a wireless device via a personal area network; and
a processor, adapted to selectively disable the vehicle responsive to commands from at least one of the operations center and the wireless device.

2. (canceled)

3. The system of claim 1, wherein the personal area network comprises a Bluetooth network.

4. The system of claim 1, wherein the personal area network comprises a ZigBee network.

5. A system for relaying an alert concerning a trigger event to a user, comprising:
a wireless device; and
an onboard device located on a vehicle, the onboard device comprising:
a wireless communications interface for receiving, from an operations center remotely located with respect to the vehicle, a message comprising an alert concerning a trigger event;
a personal area network interface for relaying the alert to the wireless device via a personal area network; and
a processor, adapted to selectively disable the vehicle responsive to commands from at least one of the operations center and the wireless device.

6. The system of claim 5, wherein the wireless device is adapted to communicate with the operations center using a short message service (SMS) communication channel.

7. The system of claim 5, wherein the wireless device is adapted to communicate with the operations center using a voice communication channel.

8. The system of claim 5, wherein the wireless device is adapted to communicate with the operations center using an email communication channel.

9. The system of claim 5, wherein the wireless device comprises one selected from the group consisting of:
a mobile telephone;
a handheld computer;
a laptop computer; and
a personal digital assistant.

10. The system of claim 5, wherein the wireless device comprises a component installed in the vehicle.

11. The system of claim 5, wherein the wireless device comprises a component communicatively coupled to at least one of a navigation system installed in the vehicle, a communications network operating in the vehicle, an engine control module, a transmission control module, and a control module for controlling a component of the vehicle.

12. The system of claim 11, wherein the wireless device is controllable via input components associated with the navigation system, and wherein the navigation system displays output related to operation of the wireless device.

13. The system of claim 5, wherein the wireless device is adapted to receive user entry of a password.

14. The system of claim 13, wherein the wireless device is adapted to transmit the entered password to the operations center for validation.

15. The system of claim 13, wherein the wireless device is adapted to transmit the entered password to the onboard device for validation.

16. The system of claim 15, wherein the onboard device is adapted to validate the entered password.

17. The system of claim 15, wherein the onboard device is adapted to relay the entered password to the operations center for validation.

18. The system of claim 13, wherein the processor disables the vehicle responsive to a predetermined number of unsuccessful password entry attempts.

19. The system of claim 5, wherein the wireless device is adapted to communicate with the operations center via a wireless telephone network.

20. The system of claim 5, wherein the onboard device is adapted to transmit messages to the wireless device via the personal area network, and wherein the wireless device is adapted to output messages to a user.

21. The system of claim 20, wherein the messages comprise text-based alerts.

22. The system of claim 5, wherein the wireless device is adapted to receive input from a user specifying operational preferences, and wherein the onboard device is adapted to receive specified operational preferences from the wireless device and to reconfigure its operation in response to the received specified operational preferences.
